(19) United States
(12) Patent Application Publication
(10) Pub. No.: US 2015/0010686 A1
(43) Pub. Date: Jan. 8, 2015

(54) LOW-CALORIE PASTA AND METHOD FOR THE PRODUCTION THEREOF

(71) Applicant: Thomas LACINA, Bosco Luganese (CH)

(72) Inventors: Thomas Lacina, Bosco Luganese (CH); Marius Hoeckl, Paradiso (CH)

(73) Assignee: Thomas LACINA, Bosco Luganese (CH)

(21) Appl. No.: 14/371,764

(22) PCT Filed: Jan. 5, 2013
(86) PCT No.: PCT/CH2013/000001

§ 371 Date: Jul. 11, 2014

(30) Foreign Application Priority Data
Jan. 12, 2012 (CH) 61/12

(51) Int. Cl. A23L 1/16

(52) U.S. Cl. CPC A23L 1/16; A23V 2002/00
USPC 426/557; 426/549

(57) ABSTRACT

Repeated attempts have been made to produce low-calorie pasta that has the characteristics of conventional pasta. According to the invention, the aim is achieved using a dough made of durum wheat flour, or oat bran, microcellulose, polysaccharides, oil, an emulsifier and water. Any kind of pasta is formed from the dough and dried during a special heating cycle. According to the method, an initial water content of the produced pasta of approximately 90 wt. % in relation to the quantity of flour is reduced to a water content of 10.5 to 13 wt. %. The finished products have a good shelf life and cooking firmness. The calorific value is more than 40% lower than that of conventional pasta. The pasta produced as per the invention is suitable in particular for diets and, in a gluten-free variant, also for gluten-intolerant individuals.

The present invention relates to a dough for the production of pasta in accordance with the preamble of claims 1 and 2, and to a method for its production.

Pasta is popularly, and hitherto has been correctly, described as a fattening food. However, it is highly popular owing to its simplicity of preparation, its wealth of variants and its taste and appearance, which can be easily changed by sauces and other additions, such as meat, cheese etc.

Pasta which has a greatly reduced energy content compared with durum wheat and/or egg pasta is commercially available (inter alia from House Foods American Corporation, Garden Grove, Calif., USA) under the name “Shirataki noodles”. These transparent noodles, which are similar in consistency and in cooking behaviour to Chinese glass noodles, are obtained from the plant konjac (E425), originally native to Japan, and have since become a widely-used diet product in the USA. Their grey-stained or white colour is typical. These noodles have a gelatinous consistency, their taste is completely neutral and they are valued for their texture (gustatory property). These noodles have virtually zero calories and are therefore a very much sought-after means for dietary weight-loss.

The disadvantages with Shirataki noodles are the lack of taste, only minimal firmness to bite and an unusual appearance. Likewise, their commercial form, packaged in a liquid, is impractical and has an adverse effect on storage ability.

A method for the production of low-calorie pasta, pizzas and bread which contain cellulose is known from JP-A-2008054654. In order to produce these products, wheat flour, mucin, galactan, mannan, pectin, gum arabic, cyamoposis gum, carrageen, carboxymethyl cellulose, xanthan gum, alginates and fucoidan are mixed with water and dried or baked in a manner known per se.

The numerous chemically/industrially processed polysaccharides, and also in particular the added enzyme mucin, are classified as not unproblematic in terms of health when eaten regularly.

Microcrystalline cellulose has been proposed for the production of reduced-calorie foods (EP-A2-0 248 252). Correspondingly-produced cellulose with a grain size of <75 μm is nowadays commercially available, and is referred to as “microcellulose”. It is listed as E460i in the list of food additives.

It is therefore an object of the invention to provide pasta which is harmless in terms of health, which has a reduced energy density compared with conventional pasta (egg pasta and/or pasta with durum wheat flour) and nevertheless is easy to digest and appetising.

The pasta should be able to be produced and stored in all known forms, and after cooking—using conventional cooking times—be pleasant-tasting, largely neutral in taste and able to be cooked so that it is firm to bite (al dente).

Also in relation to its granularity, consistency behaviour and surface properties, it should not differ, or differ only insignificantly, from conventional pasta.

As far as possible, only substances of natural origin should be used. Enzymes should be dispensed with, since these might influence in particular the intestinal flora in an uncontrolled manner.

In addition, gluten-free pasta which is suitable for gluten-intolerant people should be able to be produced, without adverse effects on taste.

This object is achieved by the features of claim 1 or 2, the variant according to claim 2 making possible gluten-free pasta. The corresponding production method is described in claim 8.

The term “dough for low-calorie pasta” used in the patent claims is understood to mean a dough which, after shaping into spaghetti, ribbon pasta, macaroni, corkscrew pasta, lasagne sheets, etc., without further method steps, solely by suitable drying, yields a storable product which is ready to cook.

Advantageous embodiments of the subject of the invention are described in subsequent dependent claims.

In principle, the emulsifier mentioned in claim 3 is not necessary in order to achieve a perfectly satisfactory end product. It is however expedient for production-related reasons (speeding up the process) to use such in a manner known per se. Only emulsifiers of vegetable origin should be used.

The linearly branched polysaccharides used according to claim 4 in the pasta mixture are not metabolised in the human body, and are excreted unchanged. These substances are hydrophilic, and therefore beneficial to the digestion.

Guar gum, locust bean gum and corn starch are distinguished, particularly when combined together, by a surprisingly improved dough consistency and binding capacity. This combination, upon further processing of the dough, acts as a beneficial thickening agent, and ultimately results in readily reproducible cooking times, claim 5.

Overall, the previously-mentioned combination has a positive influence on the cooking behaviour of the pasta. In addition, in conjunction with durum wheat flour an easily digestible, tasty product is yielded.

Adding vegetable oil, in accordance with claim 6, which makes the pasta more supple, is advantageous.

In principle, virtually all vegetable, heat-resistant oils are suitable for the subject of the invention; for declaratory reasons, it is however recommended to choose the oils named in claim 7.

The method mentioned in claim 8 is also suitable for industrial manufacture and does not require any additional fabrication means with corresponding investment compared with pasta production at present.

The liquid mentioned in claim 8 is as a rule water, but may also contain additions such as emulsifiers, oils or further known additives, such as vegetable extracts and/or gelling agents.

Of course, the shaping of the pasta can be effected by extrusion and the like, corresponding to already-existing production plants which are known per se.

Particularly advantageous is a drying method according to claim 9, which intensifies the organoleptic properties of typical pasta products and in particular improves “tongue feel” and firmness to bite. Likewise, this greatly increases the shelf life of the pasta.

A drying method in a temperature range between 60° C. and 100° C. is referred to in food technology as “HT drying”. Temperatures below this, between 40° C. and 50° C., are known as “LT drying”. The method according to the invention begins in the intermediate region between high-temperature and low-temperature drying, and maintains this temperature over a time period of 5 h to 10 h. The subsequent temperature increase into the “HT region” and slow lowering results in an improvement in the surface character and consistency of the end product.

The physical property which can be established on the finished product in claim 10 characterises the storable and attractive product, at an energy density which is at least 40% lower than has been conventional hitherto.

It has been shown that packaged pasta with an excessively high moisture content very rapidly tends to form mould. On other hand, the packaged pasta should not be too dry, in order to guarantee its properties and in particular the reproducibility of the cooking times. Likewise, it was established that the end product after drying—until it is packaged—once again slightly loses moisture.

Preferred drying methods for the pasta mixtures according to the invention are illustrated as a function of temperature, moisture content and time using graphs.

These show:

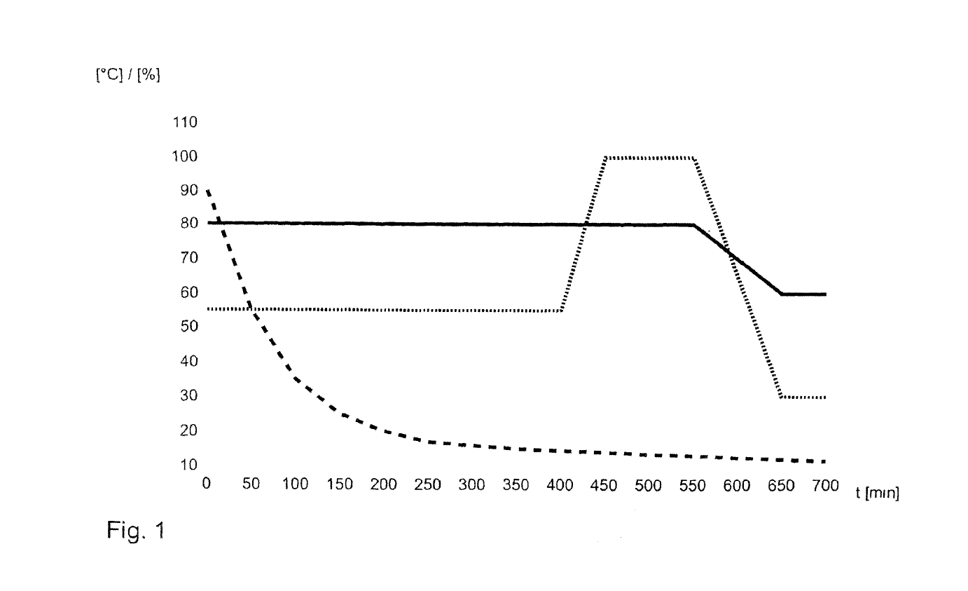

FIG. 1 an optimised drying method for particularly low-calorie pasta (examples of embodiment 1 to 7),

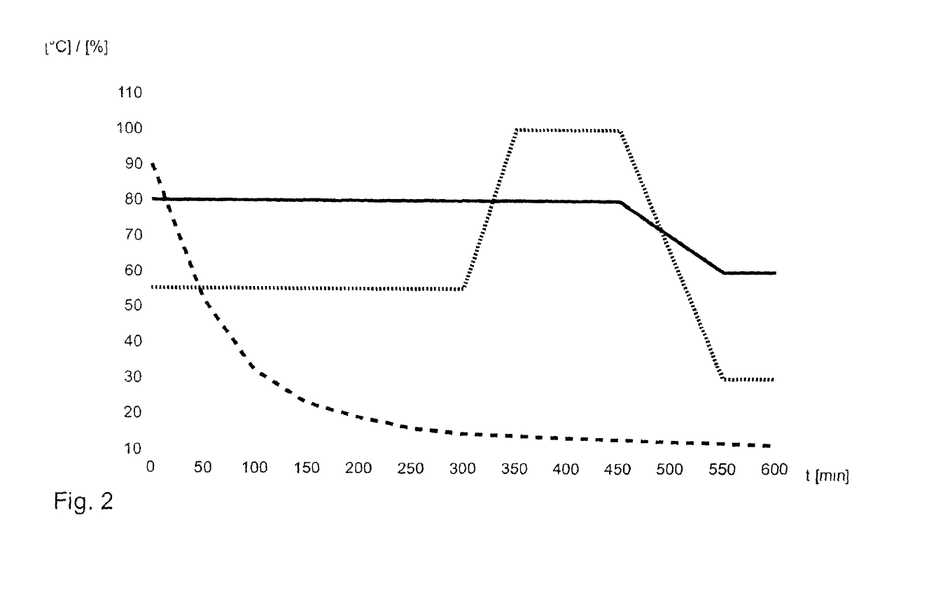

FIG. 2 an optimised drying method for particularly tasty pasta (examples of embodiment 8 and 9), on a timescale which is shorter compared with FIG. 1, and

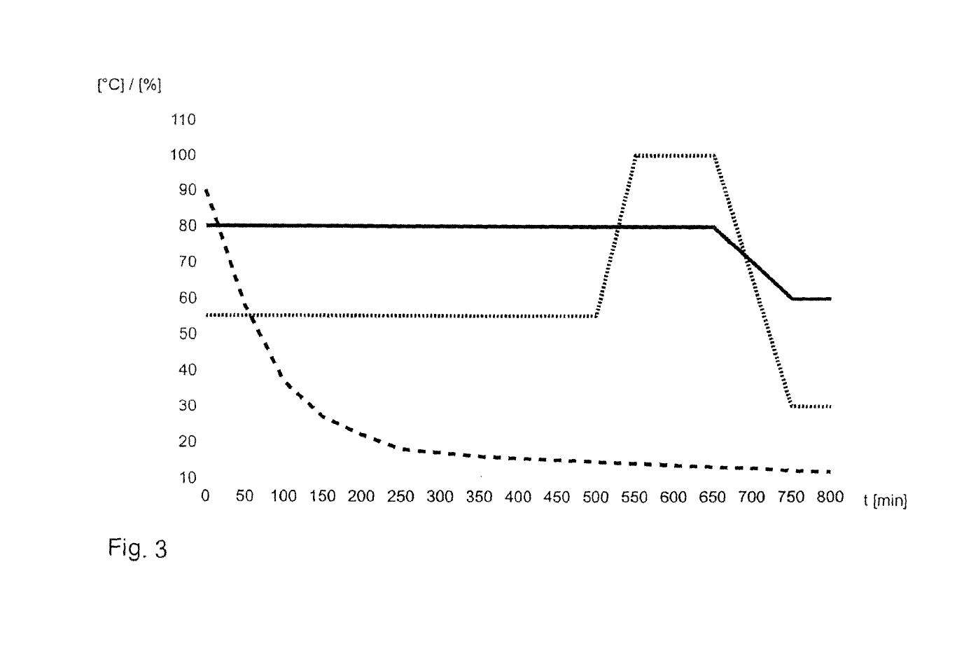

FIG. 3 an optimised drying method for gluten-free pasta (example of embodiment 10), with a timescale which is changed once again.

Below, preferred examples of embodiment of the subject of the invention are explained in table form, the weight of the individual constituents of the dough mixture being given in g (grammes). The admixing of the constituents takes place in individual method steps, wherein:
in a first step, in a mixing phase, all the dry ingredients of the flour mixture are mixed homogeneously together, then liquid is added and mixing is until no free flour constituents are visible, in
a second step, in a kneading phase, at a stirring or kneading speed which is increased compared with the mixing phase, structure formation takes place and the dough temperature is kept at 22° C. to 26° C.,
in a third step, in a swelling phase, the kneaded dough is left to rest for longer than 15 minutes, at a temperature of 18° C. to 25° C.,
in a fourth step, the dough is shaped, under pressure, and
in a fifth step, the shaped pasta is dried.

Corresponding to these method steps, the dough for low-calorie pasta is prepared as follows:

### Example of Embodiment 1

| Ingredients | Quantity in g |
|---|---|
| Durum wheat flour, double- | 55.50 |
| ground | |
| Cellulose grain size <75 μm | 44.50 |
| (E460i) | |
| Guar gum E412 | 2.20 |
| Locust bean gum E410 | 8.80 |
| Rapeseed oil | 1.10 |
| Emulsifier E471 | 2.20 |
| Water | 93.30 |

What is a decisive factor for the good properties of the end product is in particular a drying method which is adapted to the formulation.

The properties of the pasta prepared in accordance with the above recipe are (once drying has taken place):

The calorific value per 100 g pasta is 754.9 kJ (180.3 kcal). After a cooking period of 8-12 min., the pasta has a linear neutral taste; the change from firm to bite to soft (gelatinous) takes place slowly. Overall assessment: Very good.

### Example 2

| Ingredients | Quantity in g |
|---|---|
| Durum wheat flour, double- | 55.50 |
| ground | |
| Cellulose grain size <75 μm | 44.50 |
| (E460i) | |
| Guar gum E412 | 5.50 |
| Locust bean gum E410 | 5.50 |
| Rapeseed oil | 1.10 |
| Emulsifier E471 | 2.20 |
| Water | 93.30 |

The properties of Example 2 are:

Calorific value per 100 g pasta: 754.9 kJ (180.3 kcal).

Cooking period: 8-12 min. Neutral taste; smooth surface, firm to bite. Overall assessment: Very good.

### Example 3

| Ingredients | Quantity in g |
|---|---|
| Durum wheat flour, double- | 55.50 |
| ground | |
| Cellulose grain size <75 μm | 44.50 |
| (E460i) | |
| Guar gum E412 | 5.50 |
| Locust bean gum E410 | 5.50 |
| Oat bran, debittered, grain | 4.40 |
| size <100 μm | |
| Rapeseed oil | 1.10 |
| Emulsifier E471 | 2.20 |
| Water | 93.30 |

The properties of Example 3 are:

Calorific value per 100 g pasta: 748.2 kJ (178.7 kcal).

Cooking period: 8-12 min. Nutty, intense floury taste; smooth surface, good firmness to bite; Change from firm to bite to soft: Slow. Overall assessment: Very good.

### Example 4

| Ingredients | Quantity in g |
|---|---|
| Durum wheat flour, double- | 54.50 |
| ground | |
| Cellulose grain size <75 μm | 45.50 |
| (E460i) | |
| Guar gum E412 | 5.70 |
| Maizena ® | 6.80 |
| TM of Conopco, Inc., NJ, USA | |
| Locust bean gum E410 | 5.70 |
| Emulsifier E471 | 2.30 |
| Water | 95.50 |

The properties of Example 4 are:

Calorific value per 100 g pasta: 735.7 kJ (175.7 kcal).

Cooking period: 7-9 min. Neutral taste; very smooth surface, good firmness to bite after 8 min. cooking period; then change: Rapid (from firm to bite to soft). Overall assessment: Good.

### Example 5

| Ingredients | Quantity in g |
|---|---|
| Durum wheat flour, double- | 55.50 |
| ground | |
| Cellulose grain size <75 μm | 44.50 |
| (E460i) | |
| Modified guar gum E412 | 5.50 |
| Locust bean gum E410 | 5.50 |
| Rapeseed oil | 1.10 |
| Emulsifier E471 | 2.20 |
| Water | 93.30 |

The properties of Example 5 are:

Calorific value per 100 g pasta: 754.9 kJ (180.3 kcal).

Cooking period: 8-12 min. Neutral taste; smooth surface, good firmness to bite; overall assessment: Very good.

### Example 6

| Ingredients | Quantity in g |
|---|---|
| Durum wheat flour, double- | 62.50 |
| ground | |
| Cellulose grain size <75 μm | 37.50 |
| (E460i) | |
| Guar gum E412 | 12.50 |
| Polydextrose | 12.50 |
| Emulsifier E471 | 2.50 |
| Water | 100.00 |

The properties of Example 6 are:

Calorific value per 100 g pasta: 718.9 kJ (171.7 kcal).

Cooking period: 8-12 min. Neutral taste, minimally granular; relatively smooth surface, firm to bite; boil-proof.

Overall assessment: Good.

### Example 7

| Ingredients | Quantity in g |
|---|---|
| Durum wheat flour, double- | 55.50 |
| ground | |
| Cellulose grain size <75 μm | 44.50 |
| (E460i) | |
| Guar gum E412 | 5.50 |
| Locust bean gum E410 | 5.50 |
| Gelling agent E400 | 2.00 |
| Water | 94.00 |

The properties of Example 7 are:

Calorific value per 100 g pasta: 720 kJ (172 kcal). After a cooking period of 8-12 min., the pasta has a good, neutral taste; the change from firm to bite to soft takes place slowly.

### Example 8

| Ingredients | Quantity in g |
|---|---|
| Durum wheat flour, double- | 60.00 |
| ground | |
| Cellulose grain size <75 μm | 40.00 |
| (E460i) | |
| Guar gum E412 | 5.00 |
| Locust bean gum E410 | 5.00 |
| Gluten | 2.00 |
| Water | 84.40 |

The properties of Example 8 are:

Calorific value per 100 g pasta: 807.7 kJ (192.9 kcal). After a cooking period of 8-12 min., the pasta has a good, neutral taste, which very typically tastes like normal durum wheat flour pasta; the change from firm to bite to soft takes place slowly.

### Example 9

| Ingredients | Quantity in g |
|---|---|
| Durum wheat flour, double- | 60.00 |
| ground | |
| Cellulose grain size <75 μm | 40.00 |
| (E460i) | |
| Guar gum E412 | 5.00 |
| Locust bean gum E410 | 5.00 |
| Gelling agent E406 | 2.00 |
| Water | 84.40 |

The properties of Example 9 are:

Calorific value per 100 g pasta: 786.3 kJ (187.8 kcal). After a cooking period of 8-12 min., the pasta has a good, neutral taste, which very typically tastes like normal durum wheat flour pasta; the change from firm to bite to soft takes place slowly.

### Example 10 (Gluten-Free Variant)

| Ingredients | Quantity in g |
|---|---|
| Oat bran, debittered, grain | 100.00 |
| size <100 μm | |
| Cellulose grain size <75 μm | 12.50 |
| (E460i) | |
| Guar gum E412 | 6.20 |
| Locust bean gum E410 | 6.20 |
| Water | 100.00 |

The properties of Example 10 are:

Calorific value per 100 g pasta: 626.4 kJ (149.6 kcal). Cooking period: 8-12 min. Good, nutty taste; average firmness to bite; Overall assessment: Good.

Pasta Production; Recipe for Examples 1 to 9:

1. Mixing phase: Machine mixing for at least 8 min.

2. Kneading phase: Machine kneading at increased speed for least 2 min. at a dough temperature of 24° C.; dough yield DY=193; dough relaxation time: 20 min.

3. Dough working (shaping): By means of a pasta machine at an applied pressure of 150-200 bar.

4. Drying: For 280 min. to 600 min. at 55° C., then 90 to 120 min. at 70° C. to 105° C. and 40 to 80 min. at 25° C. to 30° C.

Pasta Production; Recipe for Example 10 (Gluten-Free):

This gluten-free variant in the first three method steps is prepared analogously to examples of embodiment 1 to 9.

Optimised Drying Method for Examples 1 to 7:

In the last method step, the resulting shaped pieces (spaghetti etc.) are dried in a commercially available drying machine according to a special protocol; in accordance with the graph, FIG. 1, the corresponding drying yields an Aw value of <0.5, i.e. the Activity of Water in the product which corresponds to that of conventional pasta.

In accordance with the method (see FIG. 1), the temperature is set to 55° C. and maintained for 400 min. in the drying machine. Thereafter, a temperature increase to 100° C. takes place within 50 min., this increased temperature being maintained for 100 min. Then the temperature is lowered to 30° C. over 100 min. After a further 50 min., the product is removed from the drying machine. The above temperature profile is represented in the graph by a dotted line. During the course of this temperature profile, the moisture content in the shaped product drops from 90% by weight to 12.5% by weight residual moisture, see broken line. The relative atmospheric moisture in the drying machine according to this method remains constant at 80% for approximately 550 min. This profile is marked by an unbroken line. When lowering the drying temperature from 100° C. to 30° C., at the same time the relative atmospheric moisture is set to 60%. The heat treatment, i.e. drying, consequently takes 700 min.

Optimised Drying Method for Examples 8 and 9:

In order to dry this pasta, which tastes like conventional “durum wheat flour pasta” (Tipo Italia tasting pasta), the temperature is likewise set to 55° C., FIG. 2. This temperature is maintained for 300 min.; then a temperature increase to 100° C. takes place over 50 min. This temperature is maintained for 100 min., then is lowered to 30° C. over a further 100 min. and is maintained for another 50 min. This temperature profile is represented in the graph by a dotted line. During the course of this profile, the moisture content in the shaped product drops from 90% by weight likewise to 12.5% by weight residual moisture, see broken line. The relative atmospheric moisture in the drying machine according to this method remains constant at 80% for approximately 450 min. This profile is marked by an unbroken line. When lowering the drying temperature from 100° C. to 30° C., the relative atmospheric moisture in the machine is set to 60%. The drying time here is overall only 600 min.

The drying process which is shortened by 100 min. compared with FIG. 1 allows a 14% higher material throughput and thus increased utilisation of the infrastructure.

Drying Method for Example 10 (Gluten-Free):

The drying of the gluten-free dough of Example 10 takes place in accordance with FIG. 3. The first temperature phase at 55° C. is kept constant for 500 min. (dotted line); then it is increased to 100° C. and is kept there for 100 min., and after lowering to 30° C. is kept at temperature for another 50 min. The moisture profile in the drying machine behaves analogously to the preceding examples. In this case, the total drying time is 800 min.

In all the examples of embodiment the firmness to bite of the end product can be readily controlled over the cooking time, which allows the pasta to be adapted to national customs from “al dente” (Italy) to very soft (Germany).

Upon the subsequent packaging of the pasta, care must be taken that the moisture content in the packaged product does not exceed 13% by weight, so that optimum storage ability is ensured.

NIR moisture measurement (by means of a commercially available near-infrared spectrometer) has proved effective. Owing to the short measuring times, NIR moisture measurement is also suitable for production control in the industrial production of pasta.

If the flour quality changes (inter alia, dependent on harvests), the aforementioned physical values have to be adapted. These changes however have to be kept within relatively narrow limits in order to ensure the desired product quality.

The ingredients (constituents of the dough) are all commercially available. The mixture of flour may contain all the constituents already before it is processed, which permits extremely flexible production which corresponds to current requirements.

It is recommended to use only natural emulsifiers of vegetable origin for the production of the pasta, which is advantageous not only for marketing reasons.

The pasta according to the invention has a calorific value (calorie content) which is reduced by at least 40% compared with conventional pasta, which in many cultures may serve as an important contribution to maintaining and/or restoring public health. Likewise, diabetics and people with gluten intolerance (in accordance with Example 10) can enjoy pasta without reservations.

The pasta is suitable for all known “pasta recipes”; it is not necessary to adapt the seasonings and/or sauces.

The dough according to examples of embodiment 1 to 10 has the function of an intermediate product and, if cooled suitably, can be stored over a relatively long period. This permits further production control according to requirements, so that the drying operation can take place corresponding to the sales of the pasta, which has a positive effect on the shelf life thereof.

The drying method described previously could be accelerated in terms of time and optimised once again using physical methods which are known per se.

1-10. (canceled)

11. A dough for low-calorie pasta, comprising a mixture of flour, cellulose containing a portion of microcellulose of grain size of <75 μm, polysaccharides and aqueous liquid, wherein the flour is a double-ground, high protein-containing durum wheat flour with a gluten content of >13% by weight relative to the total weight thereof, and wherein this flour has a particle size <300 μm, wherein completely proteinfree microcellulose is added to the flour, wherein the microcellulose has only a grain size of <75 μm and wherein to this mixture polysaccharides and water are added, so that the content of the entire mixture before drying thereof is 80 to 110% by weight relative to the total amount of the flour/cellulose mixture.

12. A dough for low-calorie pasta, comprising a mixture of flour, cellulose containing a portion of microcellulose of grain size of <75 μm, polysaccharides and aqueous liquid, wherein the flour is debittered oat bran with a particle size of <150 μm, wherein completely proteinfree microcellulose is added to the flour, wherein the microcellulose has only a grain size of <75 μm and wherein to this mixture polysaccharides and water are added, so that the content of the entire mixture before drying thereof is 80 to 110% by weight relative to the total amount of the flour/cellulose mixture.

13. The dough for low-calorie pasta according to claim 11, wherein an emulsifier is provided.

14. The dough for low-calorie pasta according to claim 11, wherein the polysaccharides are linearly branched, linked monosaccharides or polydextroses.

15. The dough for low-calorie pasta according to claim 14, wherein the polysaccharides are guar gum and/or locust bean gum and/or corn starch.

16. The dough for low-calorie pasta according to claim 11, wherein the flour mixture contains a vegetable oil in a concentration of 0.5 to 2% by weight, relative to the total amount of the flour/cellulose mixture.

17. The dough for low-calorie pasta according to claim 16, wherein the vegetable oil is a rapeseed oil or an olive oil.

18. A method for the production of low-calorie pasta, made with the ingredients of the dough according to claim 11, comprising a mixture of flour, cellulose containing a portion of microcellulose of grain size of <75 μm, polysaccharides and an aqueous liquid, wherein
in a first step, in a mixing phase, all the dry ingredients of the flour mixture are mixed homogeneously together, then a liquid is added and mixing is continued until no free flour constituents are visible,
in a second step, in a kneading phase, at a stirring or kneading speed which is increased compared with the mixing phase, structure formation takes place and the dough temperature is kept at 22° C. to 26° C.,
in a third step, in a swelling phase, the kneaded dough is left to rest for longer than 15 minutes, at a temperature of 18° to 25° C.,
in a fourth step, the dough is shaped, under pressure, and
in a fifth step the shaped pieces are dried.

19. The method according to claim 18, wherein the shaped pieces in the fifth method step are pre-dried over a time period of 280 to 600 min. at a temperature between 45° C. and 60° C. and then are finish-dried for 90 to 120 min. at a temperature between 70° C. and 105° C., such that a content of residual moisture of 10.5 to 13% by weight remains.

20. A low-calorie pasta, produced according to claim 18, wherein before it is stored and/or placed on the market it has a moisture of 10 to 13% by weight.
